(19) United States
(12) Patent Application Publication
(10) Pub. No.: US 2012/0055051 A1
(43) Pub. Date: Mar. 8, 2012

(54) TOOL CONTROL SYSTEM HAVING CONFIGURATION DETECTION

(76) Inventors: Eric N. Polston, Peoria, IL (US); Keith R. Kosowski, Peoria, IL (US); Ryan A. Kingdon, Peoria, IL (US); Ramona D. Cone, Mackinaw, IL (US); Yan Ma, Indianapolis, IN (US); Christopher A. Wahlmark, Washington, IL (US); Donna K. Laube, Peoria, IL (US); Ashok Krishnan, Peoria, IL (US); Benjamin D. Drake, East Peoria, IL (US); Ang Qian, Lisle, IL (US); Steven R. Krause, Chillicothe, IL (US)

(21) Appl. No.: 13/092,412

(22) Filed: Apr. 22, 2011

Related U.S. Application Data
(63) Continuation-in-part of application No. 12/874,479, filed on Sep. 2, 2010.

(51) Int. Cl. E02F 3/65; G05D 3/12

(52) U.S. Cl. 37/427; 700/275

(57) ABSTRACT

A tool control system for a scraper is disclosed. The tool control system may have a tool, a first tool actuator configured to move the tool, and a first sensor configured to detect a position parameter of at least one of the tool and the first tool actuator and to generate a corresponding first signal. The tool control system may also have a tool member operatively connected to the tool, a second tool actuator connectable to the tool member in a plurality of configurations to move the tool member, and a second sensor configured to detect a position parameter of at least one of the tool member and the second tool actuator and to generate a corresponding second signal. The tool control system may further have a controller configured to make a comparison of the first and second signals, and to determine a current connection configuration based on the comparison.

### RELATED APPLICATIONS

This Application is a continuation-in-part of application Ser. No. 12/874,749 filed on Sep. 2, 2010, which is incorporated herein by reference.

### TECHNICAL FIELD

The present disclosure relates to a tool control system and, more particularly, to a tool control system having configuration detection.

### BACKGROUND

A scraper is a construction machine used for transporting material over short distances. The scraper generally consists of a tractor that pulls a vertically movable hopper known as a bowl over a ground surface. A horizontal blade is connected to a leading lower edge of the bowl such that, when the tractor pulls the bowl forward and the bowl is lowered, the horizontal blade cuts into the ground surface and fills the bowl. After the bowl is loaded to capacity, the bowl is raised away from the ground surface and closed at the leading edge by a vertical blade known as an apron. The scraper then transports its load to a dump area where the apron is raised and an ejector located at a back end of the bowl pushes the load forward out of the bowl. The cycle is then repeated until a desired amount of material has been moved.

Varying terrain topography, material characteristics, and scraper configurations can impact the ability of the scraper to dislodge, load, retain, and dump material. An operator adjusts the depth the blade into the ground surface, a position of the apron, and other machine parameters in response to the changing conditions to operate the scraper within a desirable set of conditions and/or to produce desirable results. Although adequate in some situations, this manual control of the scraper, especially when combined with the changing conditions described above, is complicated and requires a significant amount of operator skill. For these reasons, systems that provide for automated scraper control have been contemplated.

An exemplary automated control system for a scraper is disclosed in U.S. Pat. No. 6,336,068 issued to Lawson et al. on Jan. 1, 2002 (“the '068 patent”). Specifically, the '068 patent discloses a system that controls a wheel tractor scraper in four modes of operation, including a loading operation, a hauling operation, an ejecting operation, and a return operation. The system automates these four modes of operation by controlling a hydraulic hitch and different hydraulic lifts in response to input from a plurality of apron and bowl position sensors and initial preset values from an operator. Prior to initiating the automated loading operation, the system prompts the operator to select whether a hydraulic hitch should be locked or unlocked during ejecting and returning operations; a desired apron position for the ejecting operation; a desired bowl position for the loading, hauling, and ejecting operations; an ejector speed; a blade speed; and a desired load gear. When entering values for the apron and bowl positions, the operator manually positions the horizontal blade on the ground and thereafter activates a set button to calibrate the bowl to “0” depth. This calibration routine helps to improve accuracy in automated scraper control.

While the system of the '068 patent may automate many scraper functions that previously were manually controlled, it may still be less than optimal. For example, the system may not account for configuration changes in hardware of the scraper. Without accounting for configuration changes, the system of the '068 patent may control the scraper improperly.

The present disclosure is directed to overcoming one or more of the problems set forth above and/or other problems of the prior art.

### SUMMARY

In one aspect, the present disclosure is directed to a tool control system. The tool control system may include a tool, a first tool actuator operatively connected to the tool and configured to move the tool, and a first sensor configured to detect a position parameter of at least one of the tool and the first tool actuator and to generate a corresponding first signal. The tool control system may also include a tool member operatively connected to the tool, a second tool actuator operatively connectable to the tool member in a plurality of connection configurations and configured to move the tool member relative to the tool, and a second sensor configured to detect a position parameter of at least one of the tool member and the second tool actuator and to generate a corresponding second signal. The tool control system may further include a controller in communication with the first and second sensors. The controller may be configured to make a comparison of the first signal with the second signal, and to determine a current connection configuration of the plurality of connection configurations between the second tool actuator and the tool member based on the comparison.

In another aspect, the present disclosure is directed to a computer readable medium for use by a tool control system. The computer readable medium may have executable instructions for performing a method of tool control including receiving a first input indicative of a position of a tool, and receiving a second input indicative of a position of a tool member connectable to the tool in a plurality of connection configurations. The method may also include making a comparison of the first and second inputs, and determining a current connection configuration of the plurality of connection configurations between the tool member and a tool member actuator based on the comparison.

### BRIEF DESCRIPTION OF THE DRAWINGS

FIG. 1 is a pictorial illustration of an exemplary disclosed machine;

FIG. 2 is a diagrammatic illustration of an exemplary disclosed tool control system that may be used with the machine of FIG. 1; and

FIG. 3 is a flowchart depicting an exemplary disclosed method of operating the tool control system of FIG. 2.

### DETAILED DESCRIPTION

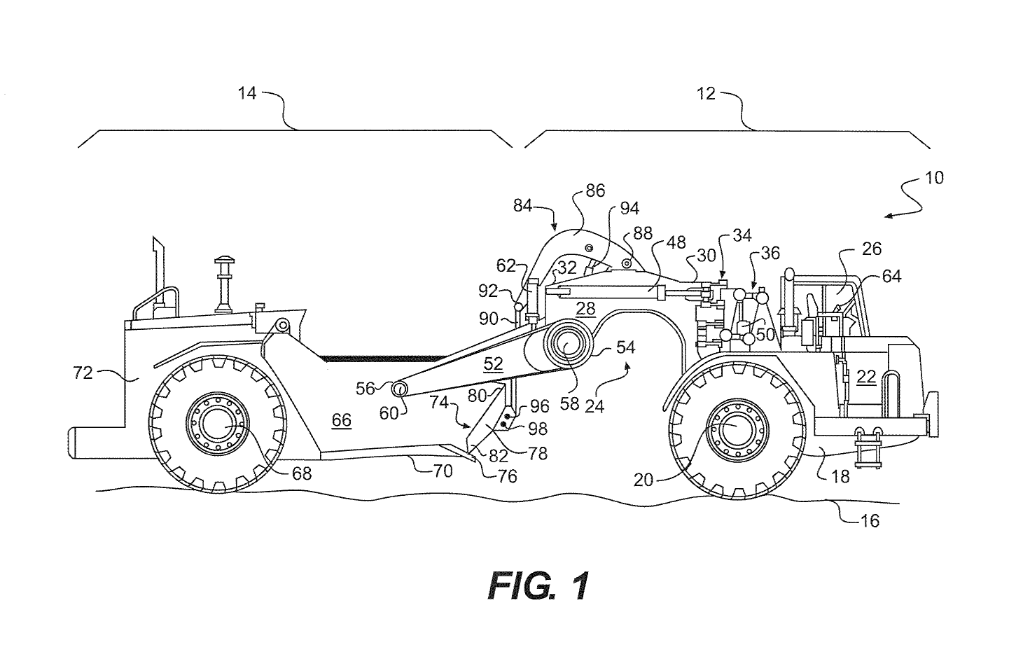

FIG. 1 illustrates an exemplary earth-moving machine 10. Machine 10, in the disclosed example, is a scraper configured to load material at a first location, transport the material from the first location to a second location, and unload the material at the second location. Machine 10 may include a tractor 12 operatively connected to a bowl portion 14 and configured to pull bowl portion 14 across a ground surface 16.

Tractor 12 may include multiple components that interact to power and control operations of bowl portion 14. Specifically, tractor 12 may include a frame 18, a front axle assembly 20, a power source 22, an articulated hitch assembly 24, and an operator station 26. Frame 18 may be connected to front axle assembly 20 and configured to support power source 22. Power source 22 may include, for example, a combustion engine that drives front axle assembly 20 and/or provides electrical and hydraulic power to bowl portion 14. Articulated hitch assembly 24 may connect tractor 12 to bowl portion 14 while allowing some relative movement between tractor 12 and bowl portion 14 in vertical and horizontal directions. Operator station 26, as will be described in more detail below, may facilitate manual control of tractor 12 and bowl portion 14.

Articulated hitch assembly 24 may include a curved main beam 28 having a front end 30 and a back end 32. Front end 30 of beam 28 may be connected through a vertical hinge joint 34 and a horizontal hinge joint 36 to frame 18 such that beam 28 may pivot both in the horizontal direction and in the vertical direction relative to frame 18. A pair of steering actuators 38 (only one shown in FIG. 1) may be associated with vertical hinge joint 34 to provide for articulated steering of machine 10. Specifically, steering actuators 38 may embody left and right hydraulic cylinders located to either side of beam 28 that extend and retract in opposition to each other to thereby cause beam 28 to pivot in the horizontal direction at vertical hinge joint 34. A cushion actuator 50, for example a hydraulic cylinder, may be associated with horizontal hinge joint 36 to provide for selective isolation of operator station 26 from vertical movements of bowl portion 14. Cushion actuator 50 may be hydraulically locked during some modes of operations such that beam 28 is inhibited from moving in the vertical direction relative to frame 18, and unlocked during other modes of operations to allow beam 28 and bowl portion 14 to float in the vertical direction relative to frame 18.

Back end 32 of beam 28 may be connected to bowl portion 14 via a pair of arms 52 located on opposing sides of beam 28 (only one side shown in FIG. 1). Each arm 52 may include a first end 54 and a second end 56. First end 54 may be pivotally connected to back end 32 of beam 28 via a first pin 58, while second end 56 may be connected to bowl portion 14 via a second pin 60. A pair of bowl actuators 62, for example hydraulic cylinders, may be connected between beam 28 at back end 32 and bowl portion 14, and configured to selectively raise bowl portion 14 away from ground surface 16 and lower bowl portion 14 toward ground surface 16 by retractions and extensions thereof, respectively.

Operator station 26 may include one or more interface devices 64 located proximal an operator seat and configured to generate control signals associated with operation of machine 10. In one example, operator interface device(s) 64 may be manipulated by an operator to raise, lower, or otherwise move components of bowl portion 14 relative to tractor 12. The same or different interface devices 64 may be used to initiate a tool configuration detection and calibration process, as will be described in more detail below.

Bowl portion 14 may include a bowl 66 connected to and supported by a rear axle assembly 68. During extension and retraction of bowl actuators 62, bowl 66 may be caused to pivot in the vertical direction about rear axle assembly 68 such that a leading end 70 of bowl 66 may be raised and lowered relative to ground surface 16. In some embodiments, an additional power source 72 may be contained within bowl portion 14 and supported by rear axle assembly 68. In these embodiments, power source 72 may be operated to drive rear axle assembly 68 and thereby push machine 10.

Bowl 66 may be a tool embodied as a generally hollow enclosure having an opening 74 at leading end 70. A horizontal blade 76 may be located at leading end 70 and positioned to selectively engage ground surface 16 as leading end 70 is lowered by the extension of bowl actuators 62. In this configuration, an extension length of bowl actuators 62 may affect a depth of blade 76 into ground surface 16 and, in conjunction with a travel speed of machine 10, a rate of material removal from ground surface 16.

Bowl portion 14 may also include an apron 78 configured to close off opening 74 of bowl 66. Apron 78 may embody a tool member that is pivotally connected to bowl 66 at a first end 80 and free to move at a second end 82 in a fore/aft machine direction relative to bowl 66. An apron actuator 84 may be connected to a front side of apron 78 (i.e., to an outside of apron 78 relative to bowl 66) and configured to selectively pull apron 78 forward to pivot from a closed position to an open position, and push apron 78 backward to pivot from the open position to the closed position. In one embodiment, apron actuator 84 may include an arm 86 pivotally connected at a first end 88 to beam 28, a rod 90 pivotally connected between a second end 92 of arm 86 and the front side of apron 78, and a hydraulic cylinder 94 connected between beam 78 and arm 86. An extension of hydraulic cylinder 94 may function to push second end 92 of arm 86 up away from beam 28, while a retraction of hydraulic cylinder 94 may function to pull second end 92 down toward beam 28. The upward movement of second end 92 of arm 86 may pull rod 90 up and cause apron 78 to pivot forward away from bowl 66 and expose opening 74. The downward movement of second end 92 may push rod 90 down and cause apron 78 to pivot backward toward bowl 66 and close off opening 74.

Apron actuator 84 may be connected to apron 78 in multiple different configurations. Specifically, rod 90 may be connectable to an upper pin 96 and to a lower pin 98. Upper pin 96 may be situated at the front side of apron 78 and closer to first end 80 than lower pin 98. When apron 78 is retracted to the closed position, as shown in FIG. 1, upper pin 86 may be located gravitationally higher than lower pin 98. When connected to upper pin 96, apron 78 may be moved by apron actuator 84 through a first range of motion. When connected to lower pin 98, apron 78 may be moved by apron actuator 84 through a second range of motion different than the first range of motion. The first and second ranges of motion may overlap some, with the first range of motion including an extreme closed position at which the second end 82 of apron 78 is closer to bowl 66 and the second range of motion including an extreme open position at which second end 82 is further away from bowl 66.

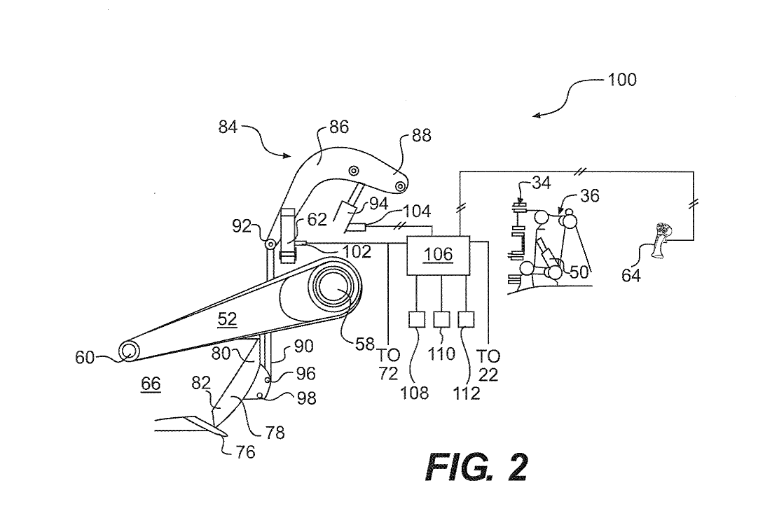

Because apron 78 may move through different ranges of motion depending on the connection configuration of apron actuator 84 with apron 78, it can be important to know the current connection configuration. In particular, for an operator to properly control operations of bowl portion 14 or for proper autonomous control of bowl portion 14 it may be necessary to know how apron 78 will move when commanded to move. In order to know how apron 78 will move, it may be necessary to know if apron actuator 84 is connected to upper pin 96 or to lower pin 98. Although this knowledge can be obtained manually through visual inspection of the connection, manual configuration detection may be tedious and prone to error. In addition, the connection configuration would still need to be programmed into machine 10 for autonomous control thereof. For this reason, machine 10 may be provided with a tool control system 100 (referring to FIG. 2) having configuration detection capabilities.

As shown in FIG. 2, tool control system 100 may include components that detect operational parameters of machine 10 and responsively determine the current connection configuration of apron actuator 84 with apron 78. Specifically, tool control system 100 may include an apron position sensor 102, a bowl position sensor 104, and a controller 106 in communication with apron and bowl position sensors 102, 104 and with interface device 64. As will be described in more detail below, controller 106 may be configured to receive signals from apron and bowl position sensors 102, 104 and from interface device 64, and execute instructions stored on a computer readable medium to perform a method of tool configuration detection and control.

Bowl and apron position sensors 102, 104 may sense the extension and retraction of hydraulic cylinders 62 and 94, respectively. In particular, bowl and apron position sensors 102, 104 may embody magnetic pickup type sensors associated with magnets (not shown) embedded within piston assemblies of hydraulic cylinders 62 and 94 that are configured to detect an extension position of hydraulic cylinders 62, 94 and generate corresponding signals. As hydraulic cylinders 62, 94 extend and retract, bowl and position sensors 102, 104 may direct the corresponding position signals to controller 106 as indications of the positions of bowl 66 and apron 78. It is contemplated that bowl and apron position sensors 102, 104 may alternatively embody other types of position sensors such as, for example, magnetostrictive-type sensors associated with a wave guide internal to hydraulic cylinders 62, 94, cable type sensors associated with cables externally mounted to hydraulic cylinders 62, 94, internally- or externally-mounted optical type sensors, or any other type of position sensors known in the art. Alternatively or additionally, bowl and apron position sensors 102, 104 may be directly associated with bowl 66 and apron 78 to directly sense a position of these components relative to each other and/or relative to ground surface 16 and to generate corresponding signals to be sent to controller 106, if desired.

Controller 106 may include any components or combination of components for monitoring, recording, storing, indexing, processing, and/or communicating operational aspects of machine 10 described above. These components may include, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from types of computer program products or computer-readable media, such as computer chips and secondary storage devices, including hard disks, floppy disks, optical media, CD-ROM, or other forms of RAM or ROM. Controller 106 may execute sequences of computer program instructions stored on the computer readable media to perform methods of tool configuration detection and control that will be explained below.

Controller 106 may be configured to automatically determine the current connection configuration between apron actuator 84 and apron 78 based on signals from bowl and apron position sensors 102, 104. In particular, controller 106 may be configured to make a comparison of the signals from bowl and apron position sensors 102, 104, when bowl 66 and apron 78 are in particular positions, with one or more predetermined position relationships stored in memory and, based on the comparison, determine if apron actuator 84 is connected to upper pin 96 or lower pin 98. In one embodiment, the particular positions of bowl 66 and apron 78 used during automatic configuration detection may correspond with extreme positions such as a raised position of bowl 66 farthest from ground surface 16 and an extended position of apron 78 farthest from bowl 66. It is contemplated, however, that other positions of bowl 66 and apron 78 may be utilized, if desired.

In addition to detecting the current connection configuration of apron actuator 84, controller 106 may also be configured to autonomously control machine 10. Specifically, controller 106 may be in communication with one or more actuation components 108, 110, 112 (e.g., control valves) of hydraulic cylinders 50, 62, and 94, with one or both of power sources 22 and 72, and/or with other components of machine 10 to selectively lock, raise, lower, propel, retard, and/or orient portions of machine 10 such that connection configuration detection, tool calibration, and/or material removal processes may be autonomously performed. For example, controller 106 may communicate with actuation component 108 of hydraulic cylinder 50 to selectively lock or unlock horizontal hinge joint 36 and thereby inhibit or allow floating of bowl portion 14 relative to ground surface 16. Similarly, controller 106 may communicate with actuation components 110 and 112 of hydraulic cylinders 62 and 94 to raise and extend bowl 66 and apron 78 to the predetermined positions used during connection configuration detection. Controller 106 may also communicate with one or more of power sources 22, 72 and with actuation component 110 to propel machine 10 at a desired speed and to raise or lower bowl 66 to desired positions such that desired rates of material removal and transportation may be affected.

As described above, apron 78 may move through different ranges of motion depending on the connection configuration of apron actuator 84 with apron 78. Accordingly, controller 106 may be configured to control machine 10 differently based on the current connection configuration. For example, controller 106, during autonomous material loading and transporting, may affect different extension or retraction amounts and/or timings of hydraulic cylinders 62 and 94 when apron actuator 84 is connected to upper pin 96 as opposed to lower pin 98 such that a desired performance of machine 10 is achieved. Additionally or alternatively, controller 106 may affect different travel speeds of machine 10 and/or different steering of machine 10 during material loading or transporting based on the connection of apron actuator 84 to achieve the desired performance. Other autonomously controlled movements of machine 10 may also or alternatively be affected based on the current connection configuration, if desired.

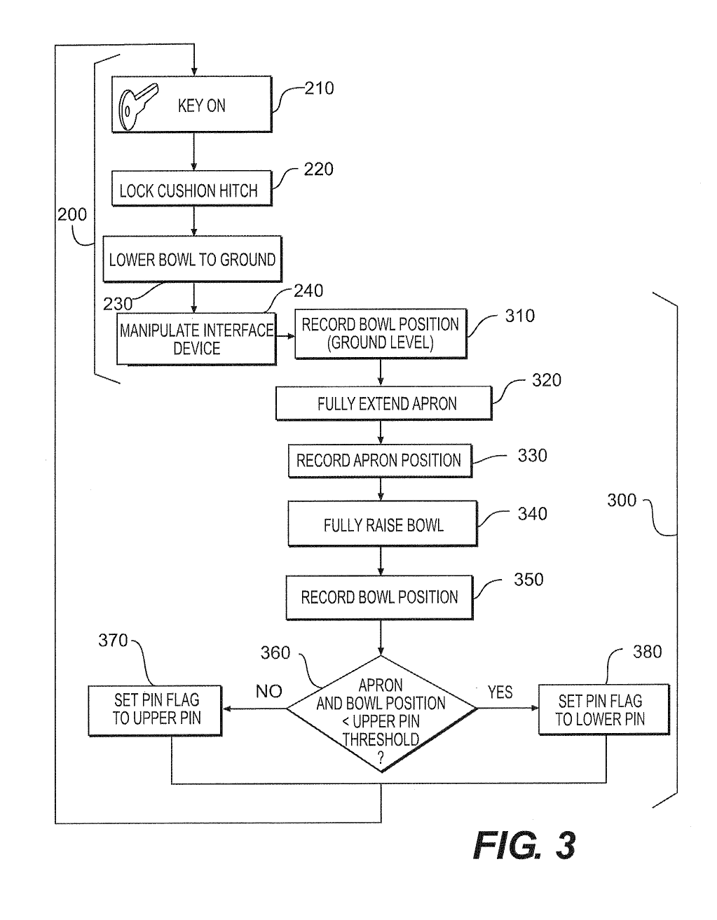

FIG. 3 illustrates an exemplary method stored as instructions on the computer readable medium that are executable by controller 106 to perform detection of the current connection configuration. FIG. 3 will be discussed in more detail in the following section to further illustrate the disclosed concepts.

### INDUSTRIAL APPLICABILITY

The disclosed tool control system may be applicable to any material handling machine configured to load, contain, transport, and/or unload material. The disclosed tool control system may provide for automatic detection of a tool's connection configuration and for autonomous control of the machine based on the connection configuration. Operation of tool control system 100 will now be explained with respect to FIG. 3.

The exemplary method of determining the current connection configuration of apron actuator 84 may include a manual portion 200 and an autonomous portion 300. It is contemplated, however, that some or all of the manual portion 200 may alternatively be completed autonomously by controller 106, if desired. The manual portion 200 of the exemplary method may begin when an operator initiates startup of machine 10 (i.e., when an operator turns a key or performs another similar action to start machine 10) (Step 200). After startup of machine 10 and before controller 106 may complete the autonomous portion 300 of the exemplary method, the operator may cause hydraulic cylinder 50 of articulation hitch 24 to lock such that relative movement between tractor 12 and bowl portion 14 in the vertical direction may be inhibited (Step 210). It is contemplated that an indication of the locked status of hydraulic cylinder 50 may be provided to controller 106 and, in some embodiments, controller 106 may be inhibited from implementing the autonomous portion if hydraulic cylinder 50 has not been locked. After locking hydraulic cylinder 50, the operator may lower bowl 66 until blade 76 engages ground surface 16 (Step 220), and then manipulate interface device 64 to trigger implementation of the autonomous portion 300. In addition to placing bowl 66 in a safe position before controller 106 implements the autonomous portion 300, the manual movement of bowl 66 to ground surface 16 may also allow controller 106 to calibrate a zero-depth position for later use in autonomous control over loading and transporting operations. Accordingly, after bowl 66 has been moved into the desired position on ground surface 16 and after receiving an activation signal from interface device 64 requesting implementation of the autonomous portion 300 of the exemplary method, controller 106 may record the current position of bowl 66 and mark this position as the zero-depth position.

After recording the zero-depth position of bowl 66, controller 106 may move apron 78 away from bowl 66 to an extreme extension position (Step 320) and record information indicative of this position (e.g., record the corresponding position of hydraulic cylinder 94 received from sensor 104) (Step 330). Controller 106 may then move bowl 66 away from ground surface 16 to an extreme raised position (Step 340) and record information indicative of this position (e.g., record the corresponding position of hydraulic cylinder 62 received from sensor 102) (Step 350). Controller may then compare the extended and raised positions of apron 78 and bowl 66 to one or more predetermined position relationships. In one example, the positions of apron 78 and bowl 66 may be compared to a threshold position(s) associated with one or both of upper and lower pins 96, 98. For example, the positions of apron 78 and bowl 66 may be compared to one or more upper pin position thresholds (Step 360). If the apron's extreme extension position is closer to bowl 66 and the bowl's extreme raised position is closer to ground surface 16 than the upper pin position thresholds, controller 106 may conclude that apron actuator 84 is connected to upper pin 96 (Step 360: No). Otherwise, controller 106 may conclude that apron actuator 84 is connected to lower pin 98 (Step 360: Yes).

Depending on the current connection configuration of apron actuator 84, controller 106 may affect operation of machine 10 differently. Specifically, when controller 106 determines that apron actuator 84 is connected to upper pin 96, controller 106 may set a software pin flag to an upper pin connection status (Step 370). In contrast, when controller 106 determines that apron actuator 84 is connected to lower pin 98, controller 106 may set the software pin flag to a lower pin connection status (Step 380). Then, during autonomous loading and transportation, controller may affect various operations of machine 10 based on the status of the software pin flag. For example, controller 106 may reference a first set of control parameters associated with the software pin flag being set to the lower pin connection status when controlling hydraulic cylinders 50, 62, 94, power sources 22, 72, and/or other components of machine 10, and reference a second set of control parameters associated with the software pin flag being set to the lower pin connection status. These control parameters may include values for cylinder extension amounts, cylinder speeds, cylinder forces, cylinder timings, etc; machine travel gear, machine travel speed, machine travel torque, etc; and other values known in the art.

Because tool control system 100 may be capable of implementing autonomous connection configuration detection, operation and control of machine 10 may be improved. For example, the amount of time and effort required from an operator of machine 10 may be reduced, and a likelihood of operator error in the detection process may be minimized. In addition, the increased precision in the detection process may facilitate more accurate autonomous control over machine 10.

It will be apparent to those skilled in the art that various modifications and variations can be made to the disclosed tool control system. Other embodiments will be apparent to those skilled in the art from consideration of the specification and practice of the disclosed tool control system. It is intended that the specification and examples be considered as exemplary only, with a true scope being indicated by the following claims and their equivalents.

What is claimed is:

1. A tool control system, comprising:
a tool;
a first tool actuator operatively connected to the tool and configured to move the tool;
a first sensor configured to detect a position parameter of at least one of the tool and the first tool actuator and to generate a corresponding first signal;
a tool member operatively connected to the tool;
a second tool actuator operatively connectable to the tool member in a plurality of connection configurations and configured to move the tool member relative to the tool;
a second sensor configured to detect a position parameter of at least one of the tool member and the second tool actuator and to generate a corresponding second signal; and
a controller in communication with the first and second sensors, the controller being configured to:
make a comparison of the first signal with the second signal; and
determine a current connection configuration of the plurality of connection configurations between the second tool actuator and the tool member based on the comparison.

2. The tool control system of claim 1, wherein each of the first and second tool actuators are cylinders, and the first and second sensors are extension sensors associated with the cylinders.

3. The tool control system of claim 1, wherein the tool is a bowl and the tool member is an apron.

4. The tool control system of claim 3, wherein the second tool actuator is connectable in a first configuration to an upper pin of the apron and in a second configuration to a lower pin of the apron.

5. The tool control system of claim 1, wherein:
the controller is further configured to receive an input indicative of the tool being in a float mode and a locked mode; and
the controller is configured to make the comparison and determine the current connection configuration only when the tool is operating in the locked mode.

6. The tool control system of claim 5, wherein the controller is further configured to receive input indicative of the tool being positioned at a desired location before making the comparison.

7. The tool control system of claim 6, wherein the desired location is at rest on a ground surface.

8. The tool control system of claim 7, wherein:
the controller is further configured to:
regulate the second tool actuator to pivot the tool member to an extreme position away from the tool; and
regulate the first tool actuator to raise the tool to an extreme position away from the ground surface; and
the comparison is made when the tool member and the tool are in the extreme positions.

9. The tool control system of claim 1, wherein the controller is configured to implement automated control of the tool and tool member differently based on the current connection configuration.

10. A computer readable medium for use by a tool control system, the computer readable medium having executable instructions for performing a method of tool configuration detection and control comprising:
receiving a first input indicative of a position of a tool;
receiving a second input indicative of a position of a tool member connectable to the tool in a plurality of connection configurations;
making a comparison of the first and second inputs; and
determining a current connection configuration of the plurality of connection configurations between the tool member and a tool member actuator based on the comparison.

11. The computer readable medium of claim 10, wherein determining a current connection configuration includes determining connection of the tool member actuator to an upper pin of the tool member and a lower pin of the tool member.

12. The computer readable medium of claim 10, wherein:
the method further includes receiving a third input indicative of the tool being in a float mode and a locked mode; and
the method includes making the comparison and determining the current connection configuration only when the tool is in the locked mode.

13. The computer readable medium of claim 12, wherein the method further includes receiving a fourth input indicative of the tool being located at a desired location before making the comparison.

14. The computer readable medium of claim 13, wherein the desired location is at rest on a ground surface.

15. The computer readable medium of claim 14, wherein:
the method further includes:
pivoting the tool member to an extreme position away from the tool; and
raising the tool to an extreme position away from the ground surface; and
making the comparison includes making the comparison when the tool member and the tool are in the extreme positions.

16. The computer readable medium of claim 10, wherein the method further includes automatically controlling movement of the tool and tool member differently based on the current connection configuration.

17. A scraper, comprising:
a tractor;
a bowl having a blade at a leading edge;
an arm having a first end pivotally connected to the tractor and a second end pivotally connected to the bowl;
a bowl cylinder connected at a first end to the tractor and at a second end to the arm, the bowl cylinder being configured to pivot the arm about the first end and thereby raise and lower the bowl;
a first sensor associated with the bowl cylinder and configured to generate a first signal indicative of a position of the bowl;
an apron pivotally connected to the bowl and having first and second pins spaced apart from each other;
an apron cylinder connected at a first end to the tractor and connectable at a second end to the first and second pins;
a second sensor associated with the apron cylinder and configured to generate a second signal indicative of a position of the apron; and
a controller in communication with the first and second sensors, the controller being configured to:
make a comparison of the first signal with the second signal;
determine if a current connection of the apron cylinder is with the first pin or the second pin based on the comparison; and
control movement of the bowl and apron cylinders differently based on the current connection.

18. The scraper of claim 17, wherein:
the controller is further configured to receive an input indicative of the tool being in a float mode and a locked mode; and
the controller is configured to make the comparison and determine the current connection only when the tool is operating in the locked mode.

19. The scraper of claim 18, wherein the controller is further configured to receive input indicative of the tool being positioned at rest on a ground surface before making the comparison.

20. The scraper of claim 19, wherein:
the controller is further configured to:
regulate the apron cylinder to pivot the apron to an extreme position away from the bowl; and
regulate the bowl cylinder to raise the bowl to an extreme position away from the ground surface; and
the comparison is made when the apron and the bowl are in the extreme positions.
